(19) United States
(12) Patent Application Publication
(10) Pub. No.: US 2022/0383656 A1
(43) Pub. Date: Dec. 1, 2022

(54) PARAMETERISING AND MATCHING IMAGES OF FRICTION SKIN RIDGES

(71) Applicant: ALGORID LTD, Wolverhampton (GB)

(72) Inventor: Peter Kitching, Wolverhampton (GB)

(21) Appl. No.: 17/626,542

(22) PCT Filed: Jul. 9, 2020
(86) PCT No.: PCT/GB2020/051657

§ 371 Date: Jan. 12, 2022

(30) Foreign Application Priority Data
Jul. 12, 2019 (GB) 1910060.1

(51) Int. Cl. G06V 40/12; G06V 10/46

(52) U.S. Cl. CPC G06V 40/1359; G06V 40/1376; G06V 10/462

(57) ABSTRACT

An apparatus and method configured to parameterise an image indicating friction skin ridges, the apparatus comprising means for: obtaining a first biometric parameter indicative of a group characteristic of a plurality of the friction ridges; obtaining a second biometric parameter indicative of one or more individual characteristics of one or more individual friction ridges of the plurality of friction ridges; and determining a third biometric parameter dependent on the first biometric parameter and dependent on the second biometric parameter. The first biometric parameter comprises a circular variance field indicative of variation of directions of the plurality of friction ridges. There is also provided a matching apparatus and method.

### FIELD OF THE INVENTION

Embodiments of the present invention relate to apparatus and methods for parameterising images of friction skin ridges. In particular, they relate to apparatus and methods for parameterising images of friction ridge prints such as fingerprints and palmprints.

### BACKGROUND TO THE INVENTION

There is a need for faster and/or more accurate identification of persons (or animals) based on their identifying information imaged in digital images. Technical applications include, but are not limited to user authentication, and criminal identification.

Biometric identifiers are an example of identifying information. Biometric identifiers are categorized as physiological and behavioral characteristics. Physiological characteristics include characteristics of the human (or animal) skin.

Characteristics of the skin include ‘friction skin ridges’. Friction skin ridges are found in regions of corrugated skin. The corrugations comprise elevated friction ridges broken up by lower furrows. Friction skin ridges occur in humans at least on the palmar surfaces of the fingers and hands, and on the plantar surfaces of the feet.

It is known that digital images can be used to capture the impression (print) left by friction ridges on a surface. Examples of suitable imaging techniques include visual light photographs, and capacitance/conductivity images for some fingerprint readers. Examples of suitable techniques for making an impression of friction ridges on a surface include exemplar printing (often deliberately ‘scanned’ prints) and latent printing (often prints left accidentally on unspecified surfaces). Sometimes, only a very small number of friction ridges are clearly distinguishable, in other words a partial print or partial latent print. There is a need for fast/accurate identification when only a partial print is available.

The patterns formed by friction skin ridges are identifying information because the patterns are individual to each person. The patterns of friction ridges have been classified into Level I detail, Level II detail, and Level III detail. The meanings and distinctions between these levels is well understood and has remained consistent since the Henry System was introduced in 1901. To summarise, Level I detail relates to group characteristics of a plurality of friction ridges. For example, a path of one or more friction ridges of non-trivial length may form a shape, and other surrounding friction ridges may deflect around the shape. A shape may be Level I detail if the shape falls into one of a plurality of known shape classes. Example shape classes include: deltas (FIG. 1(a)); whorls (FIG. 1(b)); loops (FIG. 1(c)); arches; and palmar vestiges.

Level II detail relates to individual characteristics of individual friction ridge features, and is known as minutiae detail or Galton points. A feature may be Level II minutiae detail if the feature falls into one of a plurality of known feature classes. Example feature classes include: an end point of a friction ridge (FIG. 2(a)—circled); a bifurcation (or trifurcation) of an individual friction ridge (FIG. 2(b)—circled); a ridge unit (dot) (FIG. 2(c)—circled); a short ridge (FIG. 2(d)—circled); an island of empty space within a ridge (FIG. 2(e)—circled); a spur (notch protruding from a ridge); a bridge joining adjacent ridges; and a crossover between two ridges.

Level III detail includes dimensional attributes of individual friction ridges. Examples of dimensional attributes include: pores (FIG. 3(a)—marked with arrows); incipient friction ridges (FIG. 3(b)—marked with arrows); friction ridge edge contours/protrusions (FIG. 3(c)—marked with arrow); friction ridge width; friction ridge shape; friction ridge breaks; flexion creases; and scars.

It is known that digital images can be used to capture the impression (print) left by the friction ridges on a surface. Those images can be parameterised by a computer apparatus, and a searching/matching apparatus may compare the resulting biometric parameters of different images to facilitate identification. For example, detail at a specific level such as Level I could be parameterised, and when matches occur a more detailed study could be performed.

### BRIEF DESCRIPTION OF VARIOUS EMBODIMENTS OF THE INVENTION

The invention is as defined in the claims.

The matching and parameterisation methods and apparatus described herein may together provide the functionality of an automatic friction ridge identification system such as an Automatic Fingerprint Identification System (AFIS) and/or an Automatic Palmprint Identification System (APIS). Uses include criminal investigation and/or user authentication.

### BRIEF DESCRIPTION OF THE DRAWINGS

For a better understanding of various examples of embodiments of the present invention reference will now be made by way of example only to the accompanying drawings in which:

FIGS. 1(a) to (c) illustrate different examples of Level I friction ridge shape classes;

FIGS. 2(a) to (e) illustrate different examples of Level II friction ridge minutiae point features;

FIGS. 3(a) to (c) illustrate different examples of Level III friction ridge dimensional attributes;

FIG. 4 illustrates an example of a parameterisation method;

FIGS. 5(a) to (b) illustrate an apparatus and a computer-readable storage medium, respectively;

FIGS. 6(a) to (c) illustrate an example of: (a) an image indicating friction skin ridges; (b) the image overlaid by a first biometric parameter field, and (c) the field as a three-dimensional surface;

FIGS. 7(a) to (c) illustrate an example of: (a) an image indicating friction skin ridges, the image overlaid by a second biometric parameter map indicating individual friction ridge feature positions, (b) the image overlaid by a first biometric parameter field, and also overlaid by the map, the map further comprising individual friction ridge paths, and (c) the image overlaid by the field and an augmented version of the map;

FIG. 8 illustrates an example of a matching method;

FIG. 9 illustrates an example of a three-dimensional vector between two friction ridge feature positions, based on the third biometric parameter, for the matching method;

FIGS. 10(a) to (b) illustrate examples of matching methods for matching a query image with one or more of a plurality of candidate images; and

FIG. 11 illustrates an example of a system.

### DETAILED DESCRIPTION OF VARIOUS EMBODIMENTS OF THE INVENTION

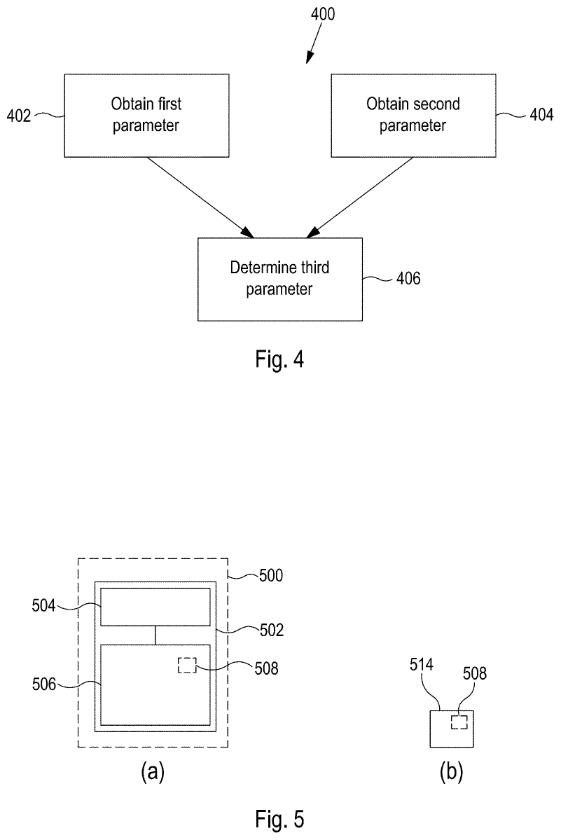

FIG. 4 illustrates a method 400 comprising: obtaining (e.g. determining or receiving) a first biometric parameter indicative of a group characteristic of a plurality of the friction ridges (block 402); obtaining (e.g. determining or receiving) a second biometric parameter indicative of one or more individual characteristics of one or more individual friction ridges of the plurality of friction ridges (block 404); and determining a third biometric parameter dependent on the first biometric parameter and dependent on the second biometric parameter (block 406).

The third biometric parameter may then be stored and/or provided to matching means (e.g. matching engine or apparatus), optionally with the first and second biometric parameters and/or other biometric parameters, to facilitate searching and matching such as AFIS or APIS.

The method 400 may be performed by the apparatus 500 of FIG. 5(a). A computer program of FIG. 5(a) or (b) may comprise instructions 508 configured to perform the method 400.

The apparatus 500 may comprise a computer, or a module thereof such as a chipset 502. In the illustration, the apparatus 500 comprises one chipset 502. In other examples, the functionality of the apparatus 500 is distributed over a plurality of computers and/or chipsets.

The chipset 502 and apparatus 500 of FIG. 5(a) includes at least one processor 504; and at least one memory 506 electrically coupled to the processor 504 and having instructions 508 (e.g. a computer program) stored therein, the at least one memory 506 and the instructions configured to, with the at least one processor 504, cause any one or more of the methods described herein to be performed.

FIG. 5(b) illustrates a non-transitory computer-readable storage medium 514 comprising the instructions 508 (computer software). The medium 514 is a delivery mechanism such as a Compact Disc Read-Only Memory (CD-ROM) or a Digital Versatile Disc (DVD) or a solid state memory, or other tangible delivery mechanism that comprises or tangibly embodies the instructions 508.

The first, second, and third biometric parameters are described below, starting with the first biometric parameter.

First Biometric Parameter

The first biometric parameter is any biometric variable that is indicative of a group characteristic of a plurality of friction ridges. The first biometric parameter may therefore provide coarse detail, to enable fast but less accurate searching and matching.

An example of a group characteristic is a shape defined by a plurality of friction ridges. The shape may comprise a Level I shape class such as a delta, a loop, or a whorl. Therefore, the first biometric parameter may usefully indicate (e.g. emphasise) the presence of a Level I friction ridge structure. The first biometric parameter may be agnostic to the specific shape class or may identify specific shape classes.

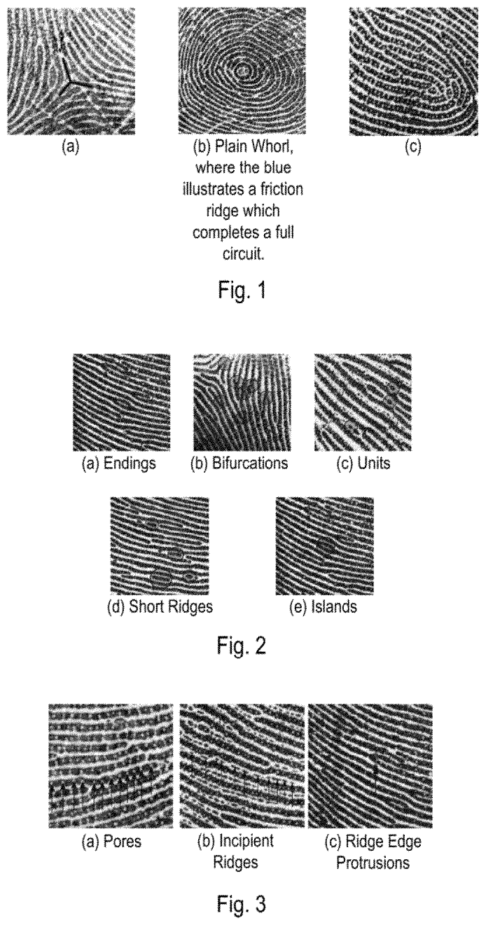

The different Level I shape classes are characterised by different variation of directions of the plurality of friction ridges. For example, three sets of friction ridges flow directly out of a centre of a delta, in different directions (e.g. FIG. 1(a)). One friction ridge flows directly out of a centre of a loop in one direction (e.g. FIG. 1(c)). No friction ridges flow directly out of a centre of a whorl (e.g. FIG. 1(b)).

In some, but not necessarily all examples, the first biometric parameter is a field covering an area defining at least a portion of the image, such as the full image or a predetermined print region thereof. Therefore, the first biometric parameter may be configured to indicate a plurality of Level I structures.

The field may comprise a plurality of measurement points in a data structure such as an array, for example. The data structure may be three-dimensional, wherein the first and second dimensions of the data structure (e.g. rows and columns of the array) define an image plane x-axis and y-axis, i.e. positions/pixels in the plane of the image, and wherein the third dimension (e.g. array elements/positions) comprises a variable indicative of the group characteristic indicated by the first biometric parameter. The variable varies across the data structure/array to vary the first biometric parameter.

Each measurement point (e.g. position in the array) may correspond to an individual non-overlapping pixel or larger area of the image. The values of the first biometric parameter at each measurement point may be dependent on the group characteristic. For example, the first biometric parameter may vary in response to variation of directions of a plurality of friction ridges surrounding the location of the measurement point. Therefore, friction ridges ‘wrapping around’ a delta, loop or whorl as shown in FIGS. 1(a) to (c) may vary the value of the first biometric parameter at a measurement point.

In a specific example, the first biometric parameter may be a field dependent on an orientation field of the friction ridges. The orientation field may be determined or known a priori. The orientation field may be determined using techniques such as convolution between a kernel and the image. The kernel may comprise an isomorphic kernel such as a Sobel operator or a Scharr operator, or an Isotropic kernel. The kernel may have a 3 by 3 size or different. Alternatively, use of a spherical quadrature filter (SQF) as an orientation operator may yield a significant reduction in error. Example SQFs include a Gaussian filter, a Poisson filter, a Derivative Gaussian filter, a Derivative Poisson filter, a Laplacian of Gaussian filter, a Log Gabor filter, or a Derivative of Log Gabor filter.

An example of a first biometric parameter field which is dependent on an orientation field is a field wherein the variable is indicative of a property of the field or orientation field. The property may be dependent on orientations in the orientation field.

An example of a property of the field or orientation field is a statistic of at least a portion of the field. Statistics include mean, variance, standard deviation, skew, dispersion, and kurtosis. In some, but not necessarily all examples, the statistic is a directional statistic. Directional statistics include circular mean, circular variance, circular standard deviation, circular skew, circular kurtosis, and circular dispersion.

In a specific implementation, the statistic may comprise a circular variance field. Circular variance advantageously changes substantially in response to changes in orientation a plurality/group of friction ridges. Therefore, peaks of circular variance are indicative of the positions and sizes of Level I structures such as deltas, loops, or whorls.

The statistic may be a local statistic relating to a portion of the field corresponding to friction ridges near the measurement point. This means that orientations of more distant friction ridges/pixels affect the value of a measurement point less or not at all.

Determining a local statistic at a measurement point may comprise determining the statistic in dependence on a calibratable distance operator. An example of a distance operator for directional statistics is a radius limit from the measurement point.

The distance operator may extend far enough to ensure that a plurality of friction ridges are within the area defined by the radius limit, hence the first biometric parameter is indicative of a group characteristic of a plurality of friction ridges. The distance operator may not extend so far so as to render the value of the measurement point insensitive to local Level I shapes.

In order to reduce the effect of Level II or Level III details on the first biometric parameter, the distance operator may be calibrated (e.g. increased to a sensible value) and/or filtering may be performed to filter out orientation estimates that arise as a result of Level II or Level III details. In a specific example, the filtering may be performed earlier as part of determining the orientation field.

An example of the filtering comprises adaptive local neighbourhood filtering (ALNF). The ALNF comprises identifying measurement points comprising a property/statistic (e.g. local circular statistic) above or below a calibratable threshold, such as circular skew above a threshold and/or circular variance below a threshold. The value of the identified measurement point in the orientation field or circular variance field may be removed or replaced. For example, the value may be replaced with a new value calculated from interpolation based on neighbouring measurement points and/or calculated from a region growing algorithm.

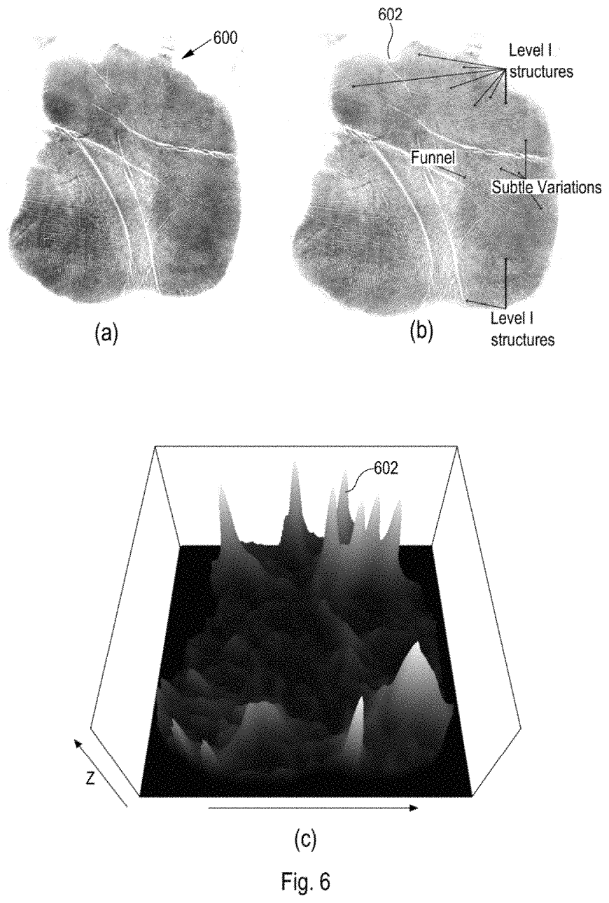

FIGS. 6(a) to (c) illustrate an example implementation wherein the first biometric parameter comprises a circular variance field. FIG. 6(a) shows an underlying image 600 of a print, which in this example is a palmprint. FIG. 6(b) shows the image 600 with a first biometric parameter 602 indicative of a circular variance field overlaid. For illustrative purposes only, the circular variance field comprises contours of constant circular variance. The contours show that peaks in circular variance occur at the locations of Level I structures such as deltas, loops, and whorls. FIG. 6(c) shows the circular variance field 602 as a surface, again for illustrative purposes.

Although circular variance is found to provide a high degree of accuracy when taken alone, it would be appreciated that the first biometric parameter could be other than circular variance, or other than a circular statistic. The first biometric parameter may or may not be dependent on an orientation field. It would be appreciated that the first biometric parameter does not have to be a field as described above. For example, the first biometric parameter could comprise a map of positions of Level I structures, or the like. The group characteristic indicated by the first biometric parameter could even be other than shape, notwithstanding that shapes such as Level I structures are a useful and important metric for rapid and reasonably accurate matching.

Second Biometric Parameter

The second biometric parameter is any biometric variable that is indicative of one or more individual characteristics of one or more individual friction ridges of a plurality of friction ridges.

For example, the second biometric parameter could identify a position, or a position and a direction, or a path (tracer with variable direction), associated with each individual friction ridge.

The second biometric parameter may usefully indicate at least one individual Level II minutiae point. Level II minutiae point locations may be identified using a Level II classifier algorithm. An example of a Level II classifier algorithm is a Crossing Number (CN) algorithm, such as the Rutovitz Crossing Number algorithm which works particularly well for friction ridge analysis, or another pattern recognition algorithm.

An example of a second biometric parameter indicating Level II minutiae points may indicate the presence of an ending, a bifurcation, a unit, a short ridge, or an island, as shown in FIG. 2(a) to (e). The second biometric parameter may be agnostic to the specific class of Level II feature or may identify the specific class (ending, bifurcation, etc.).

The second biometric parameter may indicate the position of the Level II minutiae point, for example as a single measurement point/pixel or larger group within the x-y image plane.

The direction of a friction ridge extending from a point, if used, may be calculated in various ways. For a minutiae point defined by a single friction ridge (e.g. ending), the direction may be taken as the direction of that friction ridge. For a minutiae point defined by an individual friction ridge splitting at a bifurcation, the direction may be taken as an average or combined direction (a virtual individual friction ridge) from subtracting the direction vector of one of the bifurcated friction ridges from the direction vector of another of the bifurcated friction ridges. Alternatively, the direction may be taken as that of the non-bifurcated friction ridge.

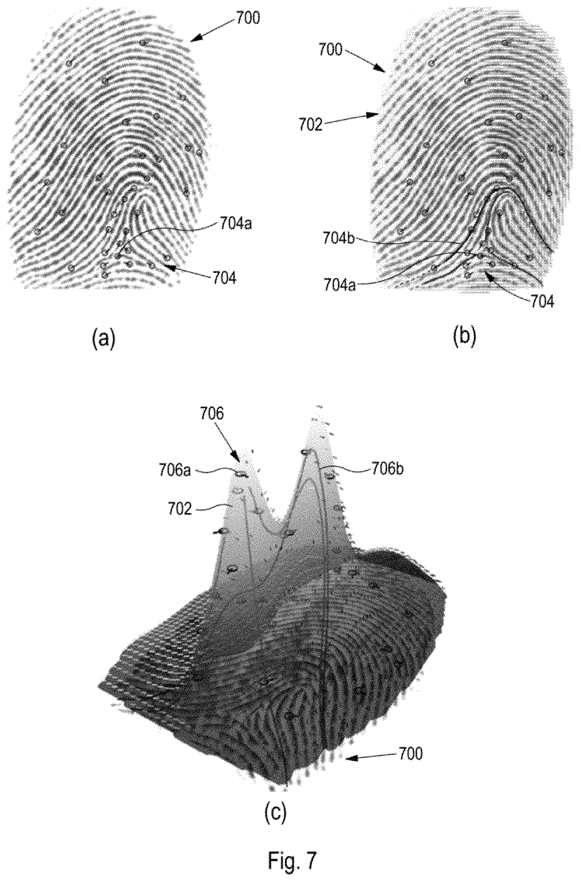

FIG. 7(a) illustrates an example implementation wherein the second biometric parameter comprises a map/collection of minutiae point points, wherein each position has a direction associated therewith. An image 700 of a fingerprint is shown, with the second biometric parameter 704 overlaid. In this instance, the second biometric parameter 704 comprises a map (e.g. list or multi-dimensional array) of minutiae points 704a, each minutiae point indicating a location and a direction of a friction ridge associated with the minutiae point.

If the second biometric parameter 704 indicates Level II detail, the third biometric parameter as described later will integrate Level I and Level II parameters to enable fast and accurate automatic analysis of both coarse and fine (minutiae) detail as part of a single search, which is particularly advantageous.

However, as will now be described, the second biometric parameter should not be regarded as solely specific to Level II minutiae points. The second biometric parameter could additionally or alternatively indicate other information and still achieve a speed/accuracy advantage. For example, the second biometric parameter could indicate Level III detail, or individual friction ridge features associated with Level I structures.

The following paragraphs considers the situation in which the second biometric parameter indicates at least one individual friction ridge associated with a Level I friction ridge structure. For example, the second biometric parameter may indicate a path of each individual friction ridge associated with a Level I friction ridge structure. See for example FIG. 7(b) wherein the map not only shows minutiae points 704a, but the map also shows paths 704b of selected friction ridges, in this case associated with a delta and with a loop.

The Level I friction ridge paths/orientations may be identified by a Level I friction ridge structure classifier algorithm, described below.

An example of a Level I friction ridge structure classifier algorithm is an algorithm that outputs one or more of: a Level I shape class (e.g. delta, loop or whorl); a representative position such as a centre point of the Level I structure; orientations (directions) of one or more selected friction ridges at least partially defining the Level I structure; or paths of the one or more selected friction ridges at least partially defining the Level I structure.

The paths/orientations of selected friction ridges may be considered as a second biometric parameter because they indicate individual friction ridges. Therefore, in an example, the Level I classifier algorithm outputs a second biometric parameter. An example implementation of the algorithm is described below.

The example Level I classifier algorithm may initially locate the centre points of Level I structures. The locating may be performed using the first biometric parameter, which is a good indicator of Level I structures as explained above. For example, a set of measurement points within a region of circular variance (R) greater than a threshold magnitude such as 0.9, e.g. 1−R>0.9, may be selected as a candidate for a Level I structure.

The centre point may be taken as the maximum value of the first biometric parameter (e.g. circular variance) within the set of measurement points. This point could be slightly skewed from the true centre, so optionally the accuracy of the centre point may be improved by: modifying the distance operator such as lowering the radius limit; recalculating the circular variance field at least in the vicinity of the centre point; and refining the centre point determination based on the recalculated circular variance field.

Once the centre point is identified, the Level I classifier algorithm may identify the shape class of the potential Level I structure based on the rationale that: three sets of friction ridges flow directly out of a centre of a delta, in different directions (FIG. 1(a)); one friction ridge flows directly out of a centre of a loop in one direction (FIG. 1(c)); and no friction ridges flow directly out of a centre of a whorl (FIG. 1(b)).

Identifying the shape class may therefore comprise determining an indicator of how many friction ridges flow directly out of the centre point. For example, the algorithm may sample the orientation field around the centre point. A plurality of samples such as 128 samples may be obtained for regular (or irregular) angular increments, by circularly sweeping around the centre point with a sweep function.

Having sampled the orientations, a directional angular distance (DAD) is calculated, in which the sampled x-y orientation estimate is subtracted from the x-y orientation of the sweep function relative to a reference direction. The DAD represents by how much a friction ridge orientation deviates from the circular sweep, and varies between −π and π.

Therefore, any friction ridge satisfying DAD=0 is parallel to the orientation of a straight line extending from the centre point. Therefore, one would expect to see three zero-crossings (DAD=0) for a delta. See for example the delta of FIG. 1(a) in which three friction ridges satisfy DAD=0 (parallel to a sweep function line from the centre point). One would expect to see one zero-crossing for a loop, and no zero-crossings for a whorl.

Therefore, the Level I classifier algorithm may automatically classify the shape into delta, loop or whorl (or others) based on the number of zero-crossings of DAD, wherein: three crossings is a delta; one crossing is a loop; and no crossings is a whorl.

Then, the algorithm may select individual friction ridges to represent the shapes, and output x-y orientations/x-y paths of the selected friction ridges (second biometric parameter(s)). The number of friction ridges to select may depend on the shape class which has been identified. For each zero-crossing of DAD, the algorithm may select a friction ridge.

For a delta, the algorithm may select friction ridges flowing from the centre point and satisfying DAD=0, i.e. a friction ridge that flows away from the centre point. Up to three friction ridges can therefore be selected for a delta.

A loop or whorl would be best represented by a looping/curving friction ridge, rather than a DAD=0 friction ridge. In order to achieve this, a looping friction ridge may be selected. The looping friction ridges are generally located to the opposite side of the DAD=0 line, as is clear from FIG. 1(c). Therefore, the algorithm may start the trace/path from a reference point separated from the centre point (the centre point is generally towards the centroid defined by the radius of curvature of the loops) and where the loops are. The reference point may be placed on an imaginary line extending from the DAD=0 line and through the centre point. The tracer length for a loop may be longer than the tracer length for a delta, to better represent a loop.

To discriminate between loops and whorls, two tracers may be created and traced in opposite directions from the reference point. The curved friction ridge is traced in two opposing directions. If the two traces do not re-converge within a threshold proximity, then that friction ridge is a loop (semi-circular, FIG. 1(c)). If those two traces do re-converge (e.g. to form a circle, FIG. 1(b)) within a threshold proximity, then the structure is a whorl.

The above-described Level I classifier algorithm is not the only possible implementation. For example, a trained machine learning algorithm could be used. However, the above approach is a fixed algorithm which is therefore much easier to tune and no training data is required. The classification can be performed near-instantaneously.

Third Biometric Parameter

The third biometric parameter is any biometric variable that is dependent on the first biometric parameter and is dependent on the second biometric parameter. Therefore, the third biometric parameter is dependent on both coarse and fine detail.

A change in the first biometric parameter changes the third biometric parameter, and a change in the second biometric parameter changes the third biometric parameter.

Therefore, the third biometric parameter may be indicative of a relationship between the first biometric parameter and the second biometric parameter.

An example of a third biometric parameter that satisfies the above conditions is an augmented version of the second biometric parameter. The second biometric parameter may be modified to include additional information based on the first biometric parameter. The additional information may be based on the variable (e.g. circular variance) of the first biometric parameter.

Consider the example wherein the second biometric parameter indicates positions and/or directions and/or paths of individual friction ridges in two dimensions (x-y image plane). The third biometric parameter may be an augmented version of the second biometric parameter, wherein the positions/directions/paths are expressed using an additional dimension (e.g. z-axis, orthogonal to the image plane) analogous to a depth map, wherein the additional spatial dimension is based on the first biometric parameter (e.g. circular variance R). Therefore, the third biometric parameter may represent a three-dimensional data structure such as (x, y, R). In some implementations, however, the third biometric parameter could represent a two-dimensional data structure such as (x, R) or (y, R) by adding/augmenting with the first biometric parameter (e.g. R) but omitting one of the dimensions of the second biometric parameter (x or y).

See for example FIG. 7(c), wherein a first biometric parameter 702 is a data structure illustrated as a three-dimensional surface with a spatial z-axis of circular variance. A third biometric parameter 706 is illustrated as a three-dimensional version of the second biometric parameter 704. The minutiae points 704a and paths 704b have been ‘projected onto the data structure or surface of the first biometric parameter. The minutiae points 704a are now three-dimensional minutiae points 706a. The paths 704b are now three-dimensional paths 706b. FIG. 7(c) also shows a modified orientation field wherein the orientation field has been optionally projected onto the data structure/surface.

In the surface representation of FIG. 7(c), minutiae points 706a of the third biometric parameter 706 are at different heights. Higher minutiae points indicate a greater magnitude of circular variance, i.e. closer proximity to a Level I structure. The lower minutiae points indicate a lower magnitude of circular variance, i.e. further from a Level I structure.

Therefore, conceptually, the third biometric parameter is a biometric parameter that indicates proximity of a position/path/direction associated with individual friction ridges, to a Level I structure/group characteristic.

In the surface representation of FIG. 7(c), paths 706b are also three-dimensional. The higher points on the paths indicate close proximity to a centre point of a Level I structure. The lower points on the paths indicate a greater distance from the centre point.

Determining the third biometric parameter 706 of FIG. 7(c) may comprise: identifying a measurement point (e.g. pixel); obtaining the circular variance/first biometric parameter at that measurement point; determining the position/second biometric parameter at that measurement point; and modifying the measurement point to identify both the circular variance and the position.

The third biometric parameter advantageously enables matching based on both fine and coarse detail using a single query, for example by comparing two paths in the three-dimensions, comparing two positions in the three dimensions, comparing two directions in the three-dimensions, or a combination thereof. This reduces the number of iterations and false-positives, and the use of a three-dimensional data structure analogous to a depth map enables efficient computation.

The third biometric parameter is especially beneficial for quickly and reliably matching partial prints and palm prints, which are more difficult than fingerprints.

Although the above example refers to augmenting the second biometric parameter with a second spatial dimension, it would be appreciated that the third biometric parameter may comprise a different data structure determined in a different way.

Searching and Matching

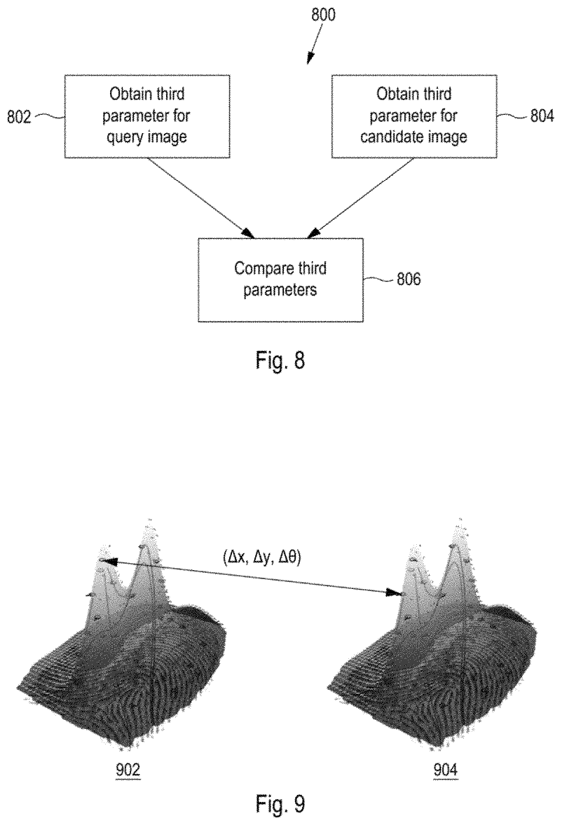

FIG. 8 illustrates a matching method 800 configured to facilitate matching of images indicating friction skin ridges, the matching method 800 comprising: obtaining the third biometric parameter (described above) for a query image (block 802); obtaining the third biometric parameter (described above) for a candidate image (block 804); and comparing the query and candidate images using the respective third biometric parameters, to determine whether a similarity condition is satisfied (block 806).

If the similarity condition is not satisfied, a next candidate image may be selected (and its third biometric parameter identified) for comparison with the query image, and/or an indication that a match has not been found may be provided, for example to terminate the method and/or provide user feedback via an output device.

If the similarity condition is satisfied, an indication that a potential or exact match has been found may be provided, for example to terminate the method and/or provide user feedback via an output device.

The comparison may compare positions, paths, directions, or a combination thereof, of the third biometric parameters. Position comparison and path comparison are described below.

Position Matching

FIG. 9 shows an example of how minutiae point positions of the third biometric parameter might be compared between a query image 902 and a candidate image 904. In FIG. 9, the query and candidate images refer to the images of the fingerprint.

The comparison may comprise identifying a first position, from the third biometric parameter of the query image 902. The first position may correspond to a position of a first minutiae point, for example point 706a of FIG. 7(c).

The comparison may then comprise identifying a second position, from the third biometric parameter of the candidate image 904. The second position may correspond to a position of a second minutiae point.

The comparison may then comprise determining a positional offset and/or angular offset between the first position and the second position. In the example of FIG. 9, the offset comprises an offset of at least one dimension of the second biometric parameter (Δx, Δy, or both Δx and Δy) and an offset of the first biometric parameter (ΔR), where R is circular variance in this example. If both positional offset and angular offset are considered, they may be calculated separately and compared separately, or merged into a single three-dimensional vector for comparison, or a combination thereof. Satisfaction of the similarity condition may require at least the offset to be zero or below a threshold.

If the offset is nonzero or above the threshold, the comparison may identify another position from the third biometric parameter of the candidate image 904, if there are any left.

A plurality of positions of the third biometric parameter of the query image 902 may be compared with a plurality of positions of the third biometric parameter of the candidate image 904 in an iterative manner, at least until the similarity condition is satisfied or the candidate image 904 is discarded and replaced with a new candidate image.

Satisfaction of the similarity condition may require one or a plurality of matches. For example, a threshold number of matching pairs of positions may be required to avoid false positives.

Additionally or alternatively to comparing positions, the comparison may compare directions. For example, it may not be enough for the positional/angular offsets to be minimal, but the indicated directions of the friction ridge features associated with the respective positions may need to be identical or within a threshold as well.

In a study of 1200 fingerprints from the Fingerprint Verification Competition (FVC) dataset, Level II minutiae point matching yielded an accuracy of 98%.

Path Matching

In some examples, the comparison may compare friction ridge paths. Paths are highly individual and may therefore provide an additional level of accuracy, for example when matching Level I structures.

A technique for comparing friction ridge paths comprises identifying a first path set, from the third biometric parameter of the query image 902. The first path set may correspond to a path set selected by the Level I friction ridge classifier. The first path set comprises one or more paths, for example a plurality/up to three paths for a delta, or one or two paths for a loop or whorl. Alternatively, the first path may be a path of a Level II friction ridge.

The comparison may then identify a second path set, from the third biometric parameter of the candidate image 904. The second path set may also be Level I (or Level II).

The first and second path sets may then be compared to determine their similarity. The paths may be compared using a matching metric configured to quantify a difference between the paths.

One difficulty arises in that two images of a same print may have been captured from different orientations. Therefore, the method 800 may comprise normalising the third biometric parameters prior to comparison. If the path sets are expressed as lists of Cartesian coordinates, they will need to be made invariant to position and rotation. The list may therefore be transformed into invariant/circular data via normalisation.

An example normalisation technique comprises using an arctangent function to convert from cartesian coordinates to polar coordinates, and comprises an orientation function causing the first angle of the path from the start/centre point to begin with a direction equal to a static reference direction (i.e. every path starts pointing the same direction).

When matching deltas, the path sets may comprise three paths extending from a centre point in different directions. Therefore, the above orientation function should be performed for three permutations. In other words, a first path is oriented into the reference direction and the comparison of path sets is performed, then the second path is oriented into the reference direction and the comparison of path sets is repeated, then the third path is oriented into the reference direction and the comparison of path sets is repeated. The permutation that provides the ‘best’ match may be taken as the result, by a min or max function.

The process for normalising loops/whorls is similar. For loops/whorls, the reference direction for the orientation function may be the DAD=0 line/friction ridge. Instead of extending from a centre point like a delta, the loop may comprise the pair of paths/traces extending from the aforementioned ‘reference point’ that was described for discriminating between loops and whorls.

Once normalised, the paths may be compared using the matching metric. The matching metric may be any appropriate metric that discriminates matching quality. For example, the matching metric could be any function that provides a first predetermined value for an exact match (same position/path), a second predetermined value for an exact mismatch, and may vary between those two predetermined values/endpoints.

Due to the manner in which the third biometric parameter is calculated, a change in the first biometric parameter can change the path, and a change in the second biometric parameter can change the path. For instance, the path may be a three-dimensional path (e.g. x, y, R).

Therefore, the matching metric requires similarity of both coarse and fine detail. Satisfaction of the similarity condition may require the matching metric to be past a threshold (above or below, depending on whether the metric is a maximisation or a minimisation function).

As with position comparison, new candidate path set pairs may be compared at least when matches do not occur. When all relevant pairs have been tested, new candidate images may be selected for comparison.

To reduce computation time, path set pairs may be identified only for the same classes of Level I shape, if class information is available.

Pre-Matching Filter

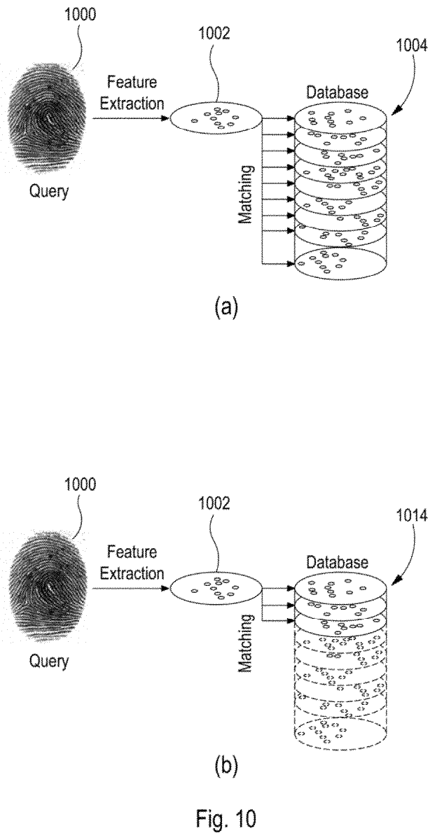

To further reduce computation time of the matching method 800, a pre-matching restrictor (filter) may be implemented. FIG. 10(a) illustrates comparing a query data item 1002 (e.g. position/path of third biometric parameter) from a query image 1000, with each of a first plurality of candidate data items 1004 of one or more candidate images, without a pre-matching filter. FIG. 10(b) illustrates comparing the query data item 1002 with each of a second plurality of candidate data items 1014 of the one or more candidate images, with a pre-matching filter. As shown in FIG. 10(b), the number of candidate data items compared with the query data item 1002 has been reduced by using a pre-matching filter.

The pre-matching filter may impose one or more conditions for restricting an extent of the comparison. For example, the pre-matching filter may restrict selection/identification of a candidate data item (e.g. positions/paths) from the third biometric parameter.

In some examples, the pre-matching filter may restrict whether a candidate data item (position/path/direction) is identified/selected for comparison based on how similar the first biometric parameter (e.g. circular variance) is.

Therefore, whether a candidate data item is selected may depend on a value of the first biometric parameter associated with that candidate data item, and on a value of the first biometric parameter associated with the query data item.

The selection may depend on comparison of the two values. The value of the first biometric parameter associated with the candidate data item may be required to be identical to or within a threshold of the value of the first biometric parameter associated with the query data item.

This significantly reduces the number of candidate data items to be compared, because only data items with a similar level of the first biometric parameter (e.g. level of circular variance) are compared. Experiments have found that 80-85% of candidate points/data items can be eliminated, where the candidate points are Level II minutiae positions and circular variance is used. A benefit of using circular variance rather than another variable is that far more data items can be eliminated prior to comparison, but with minimal impact on accuracy. This is because the finger or hand only contains a small number of Level I structures taking up a small area, so the number of candidate points (e.g. minutiae points) within a level/band of circular variance (e.g. 0.7<R<0.8, near a Level I structure) may be very small.

This pre-matching filter may be particularly useful where speed is essential, in use cases such as authentication (passport control, fingerprint scanners). In some examples, the pre-matching filter could be implemented by dividing the first biometric parameter into a predetermined level set containing a plurality of predetermined levels of the first biometric parameter (e.g. 0-0.2, 0.2-0.4, etc.). Only candidate data items within the same level set as the query data item may be selected. In some examples, the pre-matching filter could be implemented by defining the threshold(s) relative to the first biometric parameter based on the value of the first biometric parameter of the query data item (e.g. range Rn±0.1 where Rn is the circular variance R at the candidate point n). Only candidate data items within the range defined by the threshold(s) may be selected.

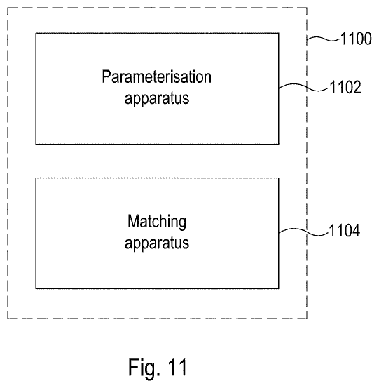

Finally, FIG. 11 shows a system 1100 for automatic friction ridge identification, where the parameterisation and matching may be performed at different computers. The system comprises a parameterisation apparatus 1102 for determining the third parameter, and a matching apparatus 1104 for performing the matching method 800. Each of the apparatus 1102, 1104 may be implemented as shown in FIG. 5(a). The matching apparatus may have access to a non-volatile memory (not shown) where the biometric parameter(s) are stored on a permanent or semi-permanent basis by the parameterisation apparatus.

Alternatively, the two functions of the system 1100 may be performed at the same apparatus/computer.

As used here ‘module’ refers to a unit or apparatus that excludes certain parts/components that would be added by an end manufacturer or a user.

The blocks illustrated in the FIGS. 4 and 8 may represent steps in a method and/or sections of code in the computer program 508. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed. According to various, but not necessarily all, embodiments of the invention there is provided a method of parameterising an image indicating friction skin ridges, the method comprising: obtaining a first biometric parameter indicative of a group characteristic of a plurality of the friction ridges; obtaining a second biometric parameter indicative of one or more individual characteristics of one or more individual friction ridges of the plurality of friction ridges; and determining a third biometric parameter dependent on the first biometric parameter and dependent on the second biometric parameter.

Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not. Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising at least one processor, and at least one memory electrically coupled to the processor and having instructions stored therein, the at least one memory and the instructions configured to, with the at least one processor, parameterise an image indicating friction skin ridges by at least:
obtaining a first biometric parameter indicative of a group characteristic of a plurality of the friction ridges;
obtaining a second biometric parameter indicative of one or more individual characteristics of one or more individual friction ridges of the plurality of friction ridges; and
determining a third biometric parameter dependent on the first biometric parameter and dependent on the second biometric parameter,
wherein the first biometric parameter comprises a circular variance field indicative of variation of directions of the plurality of friction ridges.

2. The apparatus of claim 1, wherein determining the third biometric parameter comprises augmenting the second biometric parameter with information based on the first biometric parameter, and wherein the third biometric parameter is the augmented second biometric parameter.

3. The apparatus of claim 1, wherein the group characteristic is indicative of Level I friction ridge structures.

4. The apparatus of claim 1, wherein the one or more individual friction ridge features associated with the second biometric parameter are selected individual friction ridge features.

5. The apparatus of claim 4, wherein the one or more selected individual friction ridge features associated with the second biometric parameter comprise at least one of:
at least one individual friction ridge feature identified using a Level I friction ridge structure classifier; or
at least one individual friction ridge feature identified using a Level II individual friction ridge feature classifier.

6. The apparatus of claim 1, wherein the one or more individual characteristics indicated by the second biometric parameter comprise at least one of:
position indications of individual friction ridge feature positions;
direction indications of individual friction ridge directions; or
path indications of individual friction ridge paths.

7. The apparatus of claim 6, wherein determining the third biometric parameter comprises adding a dimension to the at least one of position indications, direction indications, or path indications, and wherein the added dimension defines a variable indicative of the group characteristic as indicated by the first biometric parameter.

8. The apparatus of claim 7, wherein the second biometric parameter comprises a map of the at least one of position indications, direction indications, or path indications, wherein determining the third biometric parameter comprises projecting the map on to a three-dimensional data structure, wherein the first and second dimensions of the data structure define positions in a plane of the image, and wherein the third dimension defines the added dimension.

9. The apparatus of claim 8, wherein the third biometric parameter comprises at least one of:
indications of three-dimensional positions of individual friction ridge features in the three-dimensional data structure;
indications of three-dimensional paths of individual friction ridges in the three-dimensional data structure; or
indications of three-dimensional directions of individual friction ridge features in the three-dimensional data structure.

10. The apparatus of claim 1, the at least one memory and the instructions configured to, with the at least one processor, cause at least one of:
storing the third biometric parameter to facilitate matching of images indicating friction ridges; or
providing the third biometric parameter to a matching engine to facilitate matching images indicating friction ridges.

11. A method of parameterising an image indicating friction skin ridges, the method comprising:
obtaining a first biometric parameter indicative of a group characteristic of a plurality of the friction ridges;
obtaining a second biometric parameter indicative of one or more individual characteristics of one or more individual friction ridges of the plurality of friction ridges; and
determining a third biometric parameter dependent on the first biometric parameter and dependent on the second biometric parameter.

12. (canceled)

13. A matching apparatus comprising at least one processor, and at least one memory electrically coupled to the processor and having instructions stored therein, the at least one memory and the instructions configured to configured to, with the at least one processor, facilitate matching of images indicating friction skin ridges, by at least:
obtaining a third biometric parameter associated with a query image, wherein the third biometric parameter is dependent on a first biometric parameter indicative of a group characteristic of a plurality of friction ridges, wherein the first biometric parameter comprises a circular variance field indicative of variation of directions of the plurality of friction ridges, and is dependent on a second biometric parameter indicative of one or more individual characteristics of one or more individual friction ridges of the plurality of friction ridges;
obtaining a third biometric parameter associated with a candidate image; and
comparing the query and candidate images using the respective third biometric parameters, to determine whether a similarity condition is satisfied.

14. The matching apparatus of claim 13, wherein the comparing comprises at least one of:
comparing positions of friction ridge features of the query and candidate images, wherein the positions are dependent on the first and second biometric parameters of the respective images; or
comparing paths of friction ridge features of the query and candidate images, wherein the paths are dependent on the first and second biometric parameters of the respective images.

15. The matching apparatus of claim 13, comprising means for: restricting an extent of the comparison, based on the first biometric parameters associated with the query image and the candidate image.

16. The matching apparatus of claim 15, wherein the restricting comprises: determining a reference value of the first biometric parameter at a portion of the query image; and restricting the comparison to portions of the candidate image having a value of the first biometric parameter that is identical to or is within a threshold of the reference value.

17. The matching apparatus of claim 16, wherein the portion of the query image corresponds to a location of a selected friction skin ridge feature selected for the comparing.

18. The matching apparatus of claim 15: wherein if the similarity condition is not satisfied, the matching apparatus is configured to select a next candidate image for comparison with the query image; and wherein if the similarity condition is satisfied, the matching apparatus is configured to provide an indication that a potential or exact match has been found.

19. A system comprising the apparatus of claim 1, and the matching apparatus of claim 13.

20-21. (canceled)
